(19) United States
(12) Patent Application Publication
(10) Pub. No.: US 2004/0232136 A1
(43) Pub. Date: Nov. 25, 2004

(54) Heat-treating apparatus

(75) Inventors: Akihiro Hisaii, Horikawa-dori (JP); Junichi Yoshida, Horikawa-dori (JP); Shigehiro Goto, Horikawa-dori (JP)

Correspondence Address: OSTROLENK FABER GERB & SOFFEN, 1180 AVENUE OF THE AMERICAS, NEW YORK, NY, 100368403

(73) Assignee: Dainippon Screen Mfg. Co., Ltd.

(21) Appl. No.: 10/847,928

(22) Filed: May 17, 2004

(30) Foreign Application Priority Data
Mar. 23, 2004 (JP) 2004-083840
May 23, 2003 (JP) 2003-146082

(51) Int. Cl. H05B 3/68

(52) U.S. Cl. 219/444.1

(57) ABSTRACT

A heat-treating plate has three balls arranged on an upper surface thereof. Top ends of the balls slightly protrude from the upper surface of the heat-treating plate. A substrate is heated as placed on and supported by the balls of the heating plate such that a minute spacing called a proximity gap is formed between the lower surface of the substrate and the upper surface of the heating plate. The upper surface of the heat-treating plate has a high emissivity of 0.9 to 1.0 to heat the substrate efficiently and with high precision.

### BACKGROUND OF THE INVENTION

1. Field of the Invention

This invention relates to a heat-treating apparatus with a heat-treating plate for heating substrates such as semiconductor wafers.

2. Description of the Related Art

Such a heat-treating apparatus is used, for example, in a semiconductor manufacturing process for heating substrates before exposing photoresist formed on the substrates (pre-bake treatment), heating the substrates after exposure (post-exposure bake treatment) or heating the substrates after development (post-bake treatment).

The heat-treating apparatus includes a heat-treating plate disposed in a treating chamber and containing a heating device. The apparatus heats each substrate placed on the upper surface of the heat-treating plate. In order to avoid particles adhering to the lower surface of the substrate through contact between the substrate and the heat-treating plate, as described in Japanese Unexamined Utility Model Publication No. 63-193833 (1988), the heat-treating plate has balls arranged to protrude slightly from the upper surface thereof. The substrate is supported by the balls such that a minute spacing called a proximity gap is formed between the heat-treating plate and substrate, and the substrate is heated in this state.

Where the substrate is heated as supported close to the heat-treating plate with a minute spacing therebetween, heat is transferred from the heat-treating plate to the substrate mainly by heat conduction. The heat transfer occurring at this time is dependent on the distance between the upper surface of the heat-treating plate and the substrate. On the other hand, the distance between the upper surface of the heat-treating plate and the substrate is not necessarily invariable because of warping of the substrate, flatness of the upper surface of the heat-treating plate, or errors in assembling the balls. This impairs the uniformity of temperature over the substrate surface to hamper high-precision treatment of the substrate.

In a batch type heating furnace apparatus proposed heretofore (Japanese Unexamined Patent Publication No. 2001-12856), numerous substrates are loaded into a furnace including heat-treating plates arranged at a predetermined distance from upper and lower surfaces of the substrates to heat the substrates by radiant heat from the heat-treating plates. These heat-treating plates have surfaces thereof formed of a material with a high rate of heat radiation. Such a heating furnace apparatus is capable of treating substrates uniformly, but cannot be employed as a heat-treating apparatus for single-substrate treatment since the rise of temperature is very slow.

### SUMMARY OF THE INVENTION

The object of the invention, therefore, is to provide a heat-treating apparatus capable of heating substrates uniformly and quickly.

The above object is fulfilled, according to this invention, by a heat-treating apparatus for heating a substrate by supporting the substrate in a position slightly spaced from an upper surface of a heat-treating plate having a heating mechanism, wherein the heat-treating plate is given surface treatment so that the upper surface has an emissivity of at least 0.4.

This heat-treating apparatus is capable of heating the substrate uniformly and quickly.

In a preferred embodiment of the invention, the heat-treating plate is given surface treatment so that the upper surface has higher emissivity than a side surface of the heat-treating plate.

Preferably, the heat-treating plate is given surface treatment so that the side surface has low emissivity.

The side surface of the heat-treating plate may be mirror-finished.

In another preferred embodiment, the emissivity of the upper surface of the heat-treating plate is in a range of 0.9 to 1.0.

In a different aspect of this invention, a heat-treating apparatus is provided for heating a substrate by supporting the substrate in a position slightly spaced from an upper surface of a heat-treating plate having a heating mechanism, wherein the upper surface is given blackbody treatment while a side surface of the heat-treating plate is mirror-finished, and the heat-treating plate includes support members for supporting the substrate in a position 10 to 200 μm from the upper surface.

Other features and advantages of this invention will be apparent from the following detailed description of the embodiments of the invention.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a schematic side view of a heat-treating apparatus in a first embodiment of the invention;

FIG. 2 is a perspective view of the heat-treating apparatus;

FIG. 3 is a perspective view of a heat-treating plate in the first embodiment of the invention;

FIG. 4 is a plan view showing a substrate placed on the heat-treating plate;

FIG. 5 is a section taken on line A-A of FIG. 4;

FIG. 6 is a graph showing a relationship between substrate supporting height of the heat-treating plate and temperature difference;

FIG. 7 is a graph showing a relationship between emissivity of the upper surface of the heat-treating plate and temperature difference when a difference in supporting height is 0.04 mm; and

FIG. 8 is a perspective view of a heat-treating plate in a second embodiment of the invention.

### DESCRIPTION OF THE PREFERRED EMBODIMENTS

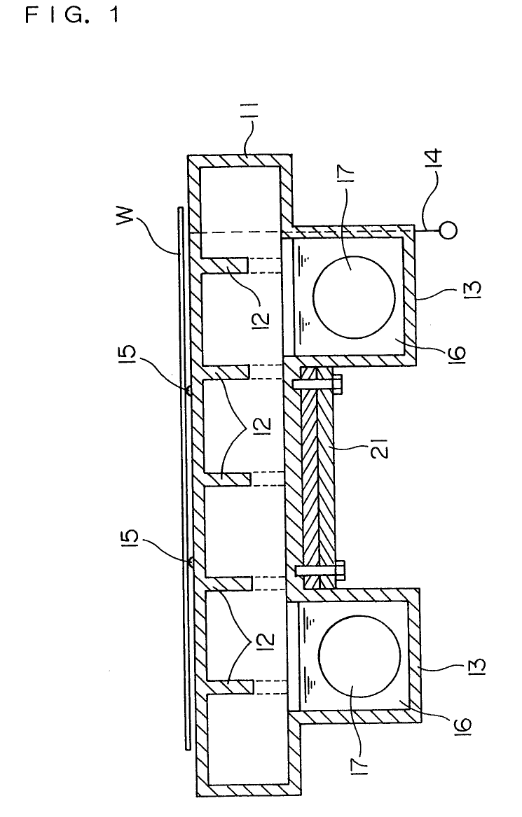

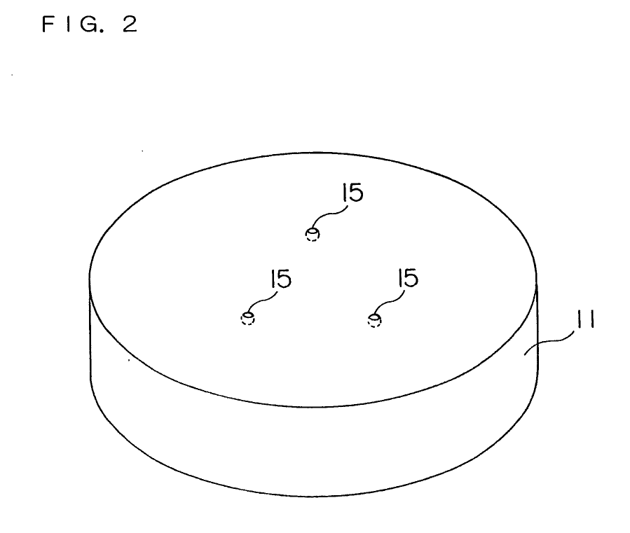

An embodiment of this invention will be described hereinafter with reference to the drawings. FIG. 1 is a schematic side view of a heat-treating apparatus in a first embodiment of the invention. FIG. 2 is a perspective view of the heat-treating apparatus. Note that operating fluid chambers 13 are omitted from FIG. 2.

This heat-treating apparatus employs a heat pipe structure for enhancing the uniformity of temperature distribution over a substrate surface with a small heat capacity. The apparatus includes a heat-treating plate 11 of hollow structure, and a temperature sensor 14 for measuring the temperature of the heat-treating plate 11.

This heat-treating plate 11 serves to heat-treat a substrate or wafer W placed above the plate 11, the wafer W having a resist solution applied thereto. The heat-treating plate 11 has a hollow cylindrical structure formed, for example, of a metal having an excellent heat-conducting characteristic, such as copper or aluminum. The heat-treating plate 11 has three balls 15 arranged on the surface thereof, which are formed of a low heat conduction material such as alumina. The balls 15 have top ends thereof slightly protruding from the surface of the heat-treating plate 11. Thus, the wafer W is heated as placed on and supported by the balls 15 of the heat-treating plate 11 such that a minute spacing called a proximity gap is formed between the lower surface of wafer W and the upper surface of heat-treating plate 11.

The proximity gap, desirably, is 10 to 500 μm, and more desirably 10 or 200 μm, in order to heat the wafer W quickly and efficiently. This minute proximity gap is made possible by the construction of the heat-treating apparatus according to this invention described hereinafter, in which heat radiation contributes largely to heating, thus not dependent on the distance between the upper surface 100 of heat-treating plate 11 and the wafer W. However, depending on the type of substrate or a mode of treatment, the proximity gap may be enlarged to about 1,000 μm.

The heat-treating plate 11, which has a heat pipe structure having inner space, includes a plurality of reinforcing rims 12 to withstand an increase in internal pressure accompanying temperature increase. A pair of operating fluid chambers 13 are formed below the inner space of the heat-treating plate 11. The operating fluid chambers 13 store an operating fluid 16 such as water. Heaters 17 are disposed in the operating fluid chambers 13 for heating the operating fluid 16.

In this heat-treating apparatus, the operating fluid 16 is heated by the heaters 17, and vapor of the operating fluid 16 moves through the inner space of the heat-treating plate 11 to transfer of the latent heat of vaporization to the heat-treating plate 11, thereby heating the heat-treating plate 11. The vapor of the operating fluid 16 having transferred the latent heat of vaporization to the heat-treating plate 11 becomes the operating fluid 16 again to be collected in the operating fluid chambers 13.

Cooling plates 21 are disposed on the lower surface of the heat-treating plate 11 between the pair of operating fluid chambers 13 for forcibly and quickly cooling the heat-treating plate 11. This cooling action takes place when, depending on the type of photoresist or other conditions, a temperature for heat-treating the wafer W is lowered below a predetermined temperature immediately before treatment.

In such a heat-treating apparatus, emissivity is 0.1 or less where the surface of the heat-treating plate 11 is formed of copper, nickel-plated copper, or aluminum. With such low emissivity of the surface of the heat-treating plate 11, an error in the distance between the upper surface of the heat-treating plate 11 and the wafer W impairs the uniformity of temperature over the surface of wafer W to hamper high-precision treatment of wafer W as noted hereinbefore. In this heat-treating apparatus, therefore, the emissivity of the upper surface of the heat-treating plate 11 desirably is 0.4, and more desirably 0.9 or higher.

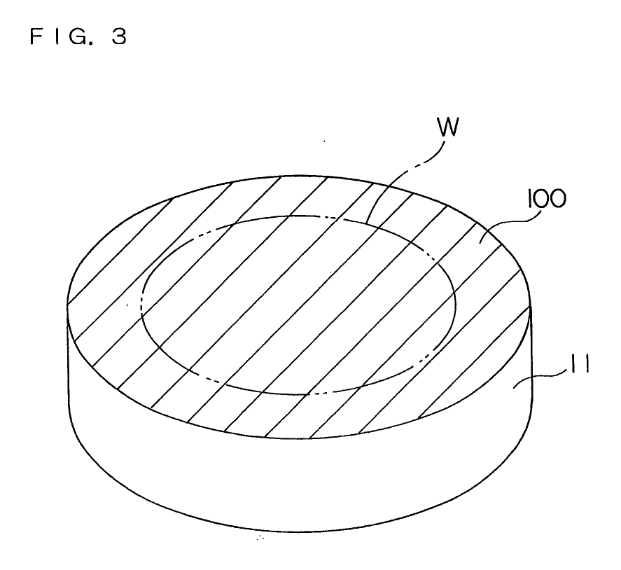

FIG. 3 is a perspective view of the heat-treating plate 11 in the first embodiment of the invention. Note that the operating fluid chambers 13 and balls 15 are omitted from FIG. 3.

The heat-treating plate 11 in the first embodiment has high emissivity over the entire upper surface 100 thereof. Specifically, the upper surface 100 of the heat-treating plate 11 is treated to be a blackbody having high emissivity. This blackbody treatment is carried out, for example, by applying a blackbody coating to the upper surface 100 of the heat-treating plate 11. In particular, the blackbody treatment is carried out by plating the upper surface 100 of the heat-treating plate 11 with black chromium. Thus, the upper surface 100 of the heat-treating plate 11 may be given high emissivity in a simple way. In this specification, blackbody treatment refers to a treatment for giving emissivity close to 1. The upper surfaces 100 of heat-treating plates 11 given the blackbody treatment all have an emissivity of 0.9 to 1.0. The upper surface of heat-treating plate 11 may be given high emissivity by producing a chemical reaction in a region several micrometers deep from the upper surface of the heat-treating plate 11. This chemical reaction is an oxidation treatment which is, for example, a hard alumite treatment when the heat-treating plate 11 is formed of aluminum.

Of the surfaces of the heat-treating plate 11, only the upper surface 100 is given high emissivity for the following reason. When all surfaces of the heat-treating plate 11 are given high emissivity, heat energy will be radiated in large amounts from the side surface and lower surface of the heat-treating plate 11 without contributing to heating of the wafer W. This lowers the heating efficiency of the heating mechanism having the heat pipe structure. In the heat-treating plate 11 in the first embodiment, high emissivity is given only to the upper surface 100 of the heat-treating plate 11 that contributes to heating of the wafer W. Further, the upper surface 100 of the heat-treating plate 11 is given higher emissivity than the side surface by mirror-finishing the side surface for low emissivity. Heat radiation from the side surface of the heat-treating plate 11 is thereby suppressed to enhance heating efficiency. This mirror finish is carried out, for example, by nickel-plating the side surface of the heat-treating plate 11. The mirror finish may be carried out by grinding the heat-treating plate 11 per se. In this specification, the mirror finish refers to a treatment to reduce emissivity close to 0.

The wafer W is heated by this heat-treating plate 11 both through heat radiation and, as in the prior art, through heat conduction. Heating through heat radiation is not dependent on the distance between the upper surface of heat-treating plate 11 and the wafer W. The wafer W may be heated with high precision even if an error occurs in the distance between the upper surface 100 of heat-treating plate 11 and the wafer W. Since the wafer W is heated also through heat conduction, the wafer W may be heated quickly.

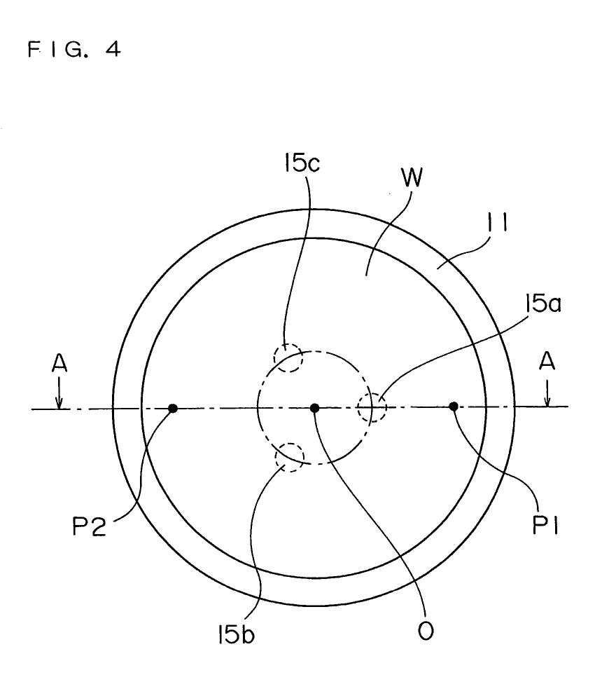

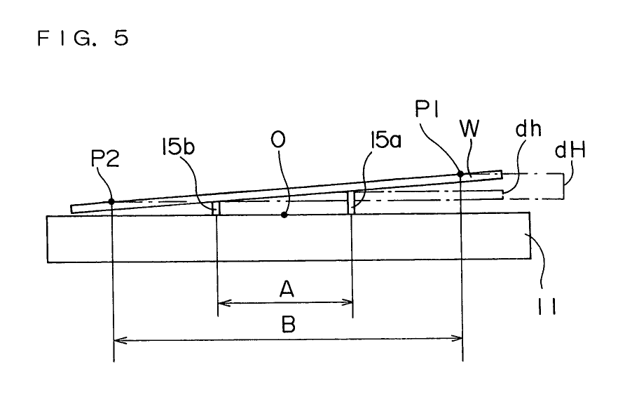

FIG. 4 is a plan view showing the wafer W placed on the heat-treating plate 11. FIG. 5 is a section taken on line A-A of FIG. 4.

The heat-treating plate 11 shown in FIGS. 4 and 5 has sensors, not shown, for measuring temperatures at measuring points P1 and P2. The heat-treating plate 11 has balls 15a, 15b and 15c of variable height. The ball 15b and ball 15c are set to the same height in time of temperature measurement. The balls 15a, 15b and 15c are arranged in three equidistant positions on a circle 100 mm in diameter.

The wafer W has a circular shape 200 mm in diameter. The measuring point P1 on the wafer W is set to 10 mm inward from the edge of the wafer W. The measuring point P2 is set to a position symmetrical to the measuring point P1 about the center of the wafer W. The wafer W is placed such that a middle point O of the circle on which the balls 15a, 15b and 15c are arranged coincides with the center of wafer W, and that the measuring point P1, measuring point P2 and ball 15a are located on a straight line. From the above relationship it is derived that, as seen in the section taken on line A-A, the distance A between the ball 15a and ball 15b is 75 mm, and the distance B between the measuring point P1 and measuring point P2 is 180 mm.

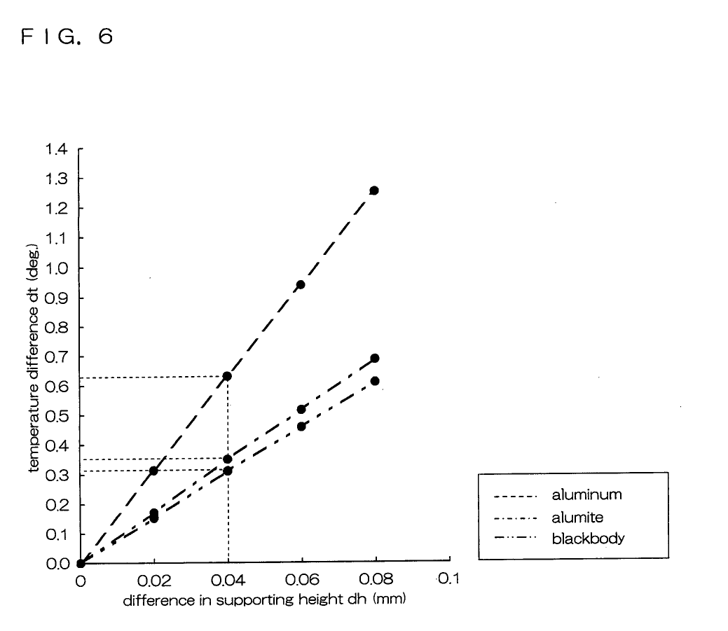

FIG. 6 is a graph showing a relationship between wafer supporting height of the heat-treating plate 11 and temperature difference.

The temperature differences dt shown in FIG. 6 are obtained by measuring temperatures at the measuring points P1 and P2 on the wafer W while varying a difference in height (hereinafter the difference dh in supporting height) between the top end of ball 15a and the top end of ball 15b (or ball 15c). As shown in FIG. 6, substantially straight lines link points on the graph plotting various values respectively obtained where the upper surface 100 of the heat-treating plate 11 is formed of aluminum, where the upper surface 100 of the heat-treating plate 11 is given alumite treatment, and where the upper surface 100 of the heat-treating plate 11 is given blackbody treatment. This indicates that the difference dh in supporting height is in a substantially linear relationship with the difference between the temperatures measured at the measuring point P1 and measuring point P2 (hereinafter temperature difference dt).

The heat-treating plate 11 actually used is assumed to have an assembly error of ±20 μm between ball 15a and ball 15b (or ball 15c), and an error of ±30 μm due to undulation of the heat-treating plate 11 per se. Consequently, the wafer W is subject to an error at maximum of {(+20 μm)+(+30 μm)}−{(−20 μm)+(−30 μm)}, i.e. an error of 100 μm. Since A:dh=B:dH where dH is a difference in height between the measuring points P1 and P2, the difference dh in supporting height is approximately 41.67 μm for setting the difference dH in height between the measuring points P1 and P2 to 100 μm.

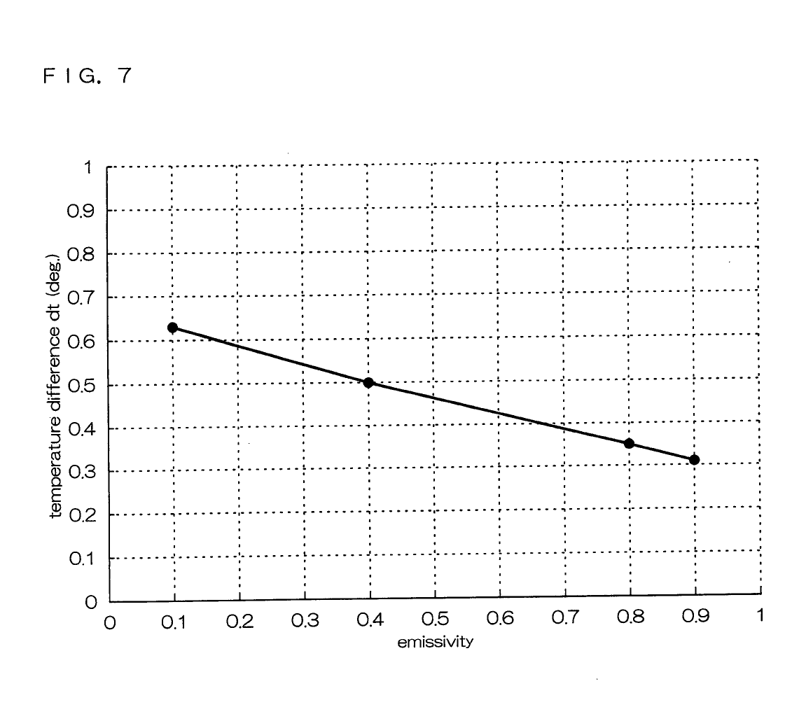

FIG. 7 is a graph showing a relationship between emissivity of the upper surface 100 of the heat-treating plate 11 and temperature difference in FIG. 6, with the difference dh in supporting height determined as described above being approximated to 0.04 mm (40 μm).

The upper surface 100 of the heat-treating plate 11 formed of aluminum has an emissivity of 0.1. The upper surface 100 of the heat-treating plate 11 given alumite treatment has an emissivity of 0.8. The upper surface 100 of the heat-treating plate 11 given blackbody treatment has an emissivity of 0.9.

As shown in FIG. 7, a substantially straight line links points on the graph plotting temperature differences dt respectively occurring where the upper surface 100 of the heat-treating plate 11 is formed of aluminum, where the upper surface 100 of the heat-treating plate 11 is given alumite treatment, and where the upper surface 100 of the heat-treating plate 11 is given blackbody treatment. This indicates that, with the difference dh in supporting height, emissivity and temperature difference dt are in a substantially linear relationship. It follows that the higher the emissivity of the upper surface 100 of the heat-treating plate 11 is, the more uniformly the wafer W is heated.

On the straight line shown in FIG. 7, the point for 0.5° C. regarded as providing good temperature uniformity of wafer W corresponds to 0.4 emissivity. Thus, the wafer W may be heated uniformly and quickly by treating the upper surface 100 of the heat-treating plate 11 to have an emissivity of 0.4 or higher.

The temperature difference that meets the temperature uniformity requirement of today is said to be within 0.3° C. As shown in FIGS. 6 and 7, the temperature difference dt is about 0.3° C. when the wafer W is heated by the heat-treating plate 11 with the upper surface 100 thereof given blackbody treatment to have an emissivity of at least 0.9. Thus, the wafer W may be heated quickly while meeting the temperature uniformity requirement of today.

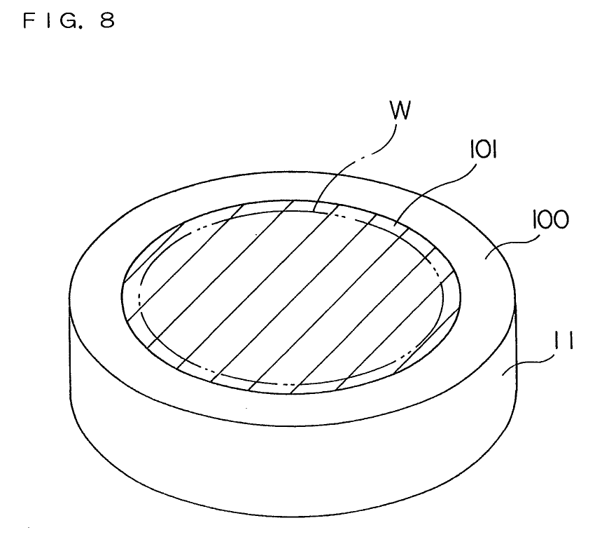

FIG. 8 is a perspective view of a heat-treating plate 11 in a second embodiment of this invention. Note that operating fluid chambers 13 and balls 15 are omitted from FIG. 8.

The heat-treating plate 11 in the second embodiment has an upper surface 100 of high emissivity over a slightly larger area 101 than the outside diameter of wafer W. More particularly, as in the first embodiment, the upper surface 100 of the heat-treating plate 11 is given blackbody treatment to have high emissivity. This blackbody treatment is carried out, for example, by applying a blackbody coating to the upper surface 100 of the heat-treating plate 11. In particular, the blackbody treatment is carried out by plating the upper surface 100 of the heat-treating plate 11 with black chromium. The upper surface 100 of heat-treating plate 11 may be given high emissivity over the area 101 about 5 mm larger than the outside diameter of wafer W by producing a chemical reaction in a region several micrometers deep from the upper surface 100 of the heat-treating plate 11. As in the first embodiment, this chemical reaction is an oxidation treatment which is, for example, a hard alumite treatment where the heat-treating plate 11 is formed of aluminum.

With this construction, high emissivity is given only to the area 101, slightly larger than the outside diameter of wafer W, on the surface 100 of the heat-treating plate 11 contributing to heating of the wafer W. This effectively prevents a radiation of heat energy from the surfaces of the heat-treating plate 11 not contributing to heating of the wafer W. This heat-treating plate 11 can heat the wafer W even more efficiently than the heat-treating plate 11 in the first embodiment.

The wafer W is heated by the heat-treating plate 11 in the second embodiment, as in the case of the heat-treating plate 11 in the first embodiment, both through heat radiation and, as in the prior art, through heat conduction. Heating through heat radiation is not dependent on the distance between the upper surface 100 of heat-treating plate 11 and the wafer W. The wafer W may be heated with high precision even if an error occurs in the distance between the upper surface 100 of heat-treating plate 11 and the wafer W. Since the wafer W is heated also through heat conduction, the wafer W may be heated quickly.

In the second embodiment described above, the upper surface 100 of heat-treating plate 11 is given high emissivity over the area 101 about 5 mm larger than the outside diameter of wafer W. Instead, the upper surface 100 may be given high emissivity over an area corresponding to the outside diameter of wafer W.

In the first and second embodiments described above, high emissivity is given only to the upper surface 100 of the heat-treating plate 11 in order to heat the wafer W efficiently. Portions other than the upper surface 100 of the heat-treating plate 11 may be given high emissivity where the heating mechanism has a large heating capacity.

This invention may be embodied in other specific forms without departing from the spirit or essential attributes thereof and, accordingly, reference should be made to the appended claims, rather than to the foregoing specification, as indicating the scope of the invention.

This application claims priority benefit under 35 U.S.C. Section 119 of Japanese Patent Application No. 2003-146082 filed in the Japanese Patent Office on May 23, 2003, and Japanese Patent Application No.2004-083840 filed in the Japanese Patent Office on Mar. 22, 2004, the entire disclosure of which is incorporated herein by reference.

What is claimed is:

1. A heat-treating apparatus for heating a substrate by supporting the substrate in a position slightly spaced from an upper surface of a heat-treating plate having a heating mechanism, wherein said heat-treating plate is given surface treatment so that said upper surface has an emissivity of at least 0.4.

2. A heat-treating apparatus as defined in claim 1, wherein said heat-treating plate is given surface treatment so that said upper surface has higher emissivity than a side surface of said heat-treating plate.

3. A heat-treating apparatus as defined in claim 2, wherein said heat-treating plate is given surface treatment so that said side surface has low emissivity.

4. A heat-treating apparatus as defined in claim 3, wherein said side surface is mirror-finished.

5. A heat-treating apparatus as defined in claim 4, wherein said side surface is mirror-finished by nickel plating.

6. A heat-treating apparatus as defined in claim 1, wherein said upper surface is given blackbody treatment.

7. A heat-treating apparatus as defined in claim 6, wherein said blackbody treatment is carried out by applying a blackbody coating to said upper surface.

8. A heat-treating apparatus as defined in claim 1, wherein the emissivity of said upper surface is in a range of 0.9 to 1.0.

9. A heat-treating apparatus as defined in claim 1, wherein said heat-treating plate includes support members for supporting said substrate in a position 10 to 200 μm from said upper surface.

10. A heat-treating apparatus as defined in claim 1, wherein said upper surface is given high emissivity over an area at least corresponding to an outside diameter of the substrate.

11. A heat-treating apparatus as defined in claim 1, wherein said heating mechanism has a heat pipe structure.

12. A heat-treating apparatus as defined in claim 1, wherein said substrate has a resist solution applied thereto.

13. A heat-treating apparatus for heating a substrate by supporting the substrate in a position slightly spaced from an upper surface of a heat-treating plate having a heating mechanism, wherein:
said upper surface is given blackbody treatment while a side surface of said heat-treating plate is mirror-finished; and
said heat-treating plate includes support members for supporting said substrate in a position 10 to 200 μm from said upper surface.

14. A heat-treating apparatus as defined in claim 13, wherein said substrate has a resist solution applied thereto.
